(19) United States
(12) Patent Application Publication
(10) Pub. No.: US 2024/0159477 A1
(43) Pub. Date: May 16, 2024

(54) HEAT EXCHANGER

(71) Applicant: Valeo Autosystemy Sp. z o.o., Skawina (PL)

(72) Inventors: Dariusz POTOK, Skawina (PL); Agnieszka BUJAS, Skawina (PL); Lukasz BIALO, Skawina (PL); Mateusz LIPOWSKI, Skawina (PL)

(73) Assignee: Valeo Autosystemy Sp. z o.o., Skawina (PL)

(21) Appl. No.: 18/551,062

(22) PCT Filed: Feb. 23, 2022
(86) PCT No.: PCT/EP2022/054481

§ 371 Date: Sep. 18, 2023

(30) Foreign Application Priority Data
Mar. 17, 2021 (EP) 21163035.5

(51) Int. Cl. F28F 9/00; F28D 7/16

(52) U.S. Cl. CPC F28F 9/001; F28D 7/1684; F28F 9/005

(57) ABSTRACT

A heat exchanger for exchanging heat between a first fluid and a second fluid is disclosed in accordance with an embodiment of the present invention. The heat exchanger includes a first manifold, a second manifold, a bundle of heat exchange elements and a housing. The bundle of heat exchange elements for the first fluid axially extend and provide a fluidal communication between the manifolds. The housing for the second fluid encapsulates at least part of the heat exchange elements to form a fluid tight channel for the second fluid. The housing further includes at least one sacrificial component being of material having lower galvanic potential than the remaining components.

### TECHNICAL FIELD

The present invention relates to a heat exchanger, more particularly, the present invention relates to a heat exchanger used in a corrosive environment.

### BACKGROUND OF THE INVENTION

Generally, the heat exchangers are exposed to detrimental environment conditions. The heat exchangers mounted on a vehicle are particularly subjected to diverse environment conditions as the vehicle travels in regions with different climatic conditions. The heat exchangers mounted on the vehicle are exposed to products of condensation of atmospheric water vapor that can be acidic and hence corrosive in nature. Such exposure to acidic products of condensation or any other corrosive environment can damage the brazing joint between the components of the heat exchanger joined by brazing and is detrimental for the fluid tightness of cooling/heating circuit of the heat exchanger. Particularly, such damage to the brazing joints between the components causes leakage of heat exchange fluid flowing though the cooling/heating circuit, thereby detrimentally affecting the efficiency and performance of the heat exchanger. The loose brazing joint can between components can cause rattling noise and other Noise Vibration and Harshness (NVH) issues. Further, such corrosive environment also causes depletion of dimension of the components of the heat exchanger. In case the corrosive environment causes depletion of dimension of critical components of the heat exchanger such as the housing or the heat exchange tubes and causes internal pitting and cracks, there are chances of leakage of heat exchange fluid through the corroded elements, thereby detrimentally affecting the efficiency and performance of the heat exchanger. In case the heat exchanger fails to efficiently perform it's function, the efficiency and performance of the elements supplied with the heat exchange fluid by the heat exchanger is also detrimentally affected. For example, in case the heat exchanger is a Water Charge Air Cooler, hereinafter referred to as WCAC, the inefficient performance of the WCAC causes insufficient cooling of the air thereby as compared to when the air is cooled by efficiently operating WCAC. The insufficiently cooled air supplied to the engine by inefficiently operating WCAC is ineffective in improving efficiency and performance of the engine, thereby limiting the advantages of configuring the engine with the WCAC. The corrosion can also lead to mechanical failure, frequent maintenance and replacement of critical components of the heat exchanger, thereby reducing the service life of the heat exchanger and increasing the maintenance costs.

Although, the harmful effects of corrosion of the critical elements of the heat exchanger can be reduced by increasing the thickness of the critical components of the heat exchanger, however, increasing the thickness of the sections of the heat exchanger components also increases the overall dimension and weight of the heat exchanger. The increase in dimension of the heat exchanger causes packaging issues and increase in overall weight of the vehicle reduces the fuel efficiency of the vehicle.

Accordingly, there is a need for a heat exchanger that prevents corrosion of critical elements of the heat exchanger and prevents problems caused by the corrosion of critical elements of the heat exchanger without increasing the overall weight and dimension thereof. More specifically, there is a need for a heat exchanger that prevents cracks and pitting of the critical components of the heat exchanger, thereby increasing service life of the heat exchanger and reducing downtime, maintenance and maintenance costs, replacement costs. Furthermore, there is a need for a heat exchanger that is simple in construction and convenient to manufacture and does not involve complex manufacturing/production processes for enhancing corrosion resistance of the heat exchanger and rendering the heat exchanger robust and resistant to adverse environment conditions.

### BRIEF SUMMARY OF THE INVENTION

An object of the present invention is to provide a heat exchanger that prevents corrosion of critical elements of the heat exchanger and prevents problems caused by the corrosion of critical elements of the heat exchanger without increasing the overall weight and dimension thereof.

Another object of the present invention is to provide a heat exchanger that prevents cracks and pitting of the critical components of the heat exchanger, thereby increasing service life of the heat exchanger and reducing downtime, maintenance and maintenance costs, replacement costs.

Yet another object of the present invention is to provide a heat exchanger that is simple in construction, convenient to manufacture and does not involve complex manufacturing/production processes for enhancing corrosion resistance of the heat exchanger and rendering the heat exchanger robust and resistant to adverse environment conditions.

In the present description, some elements or parameters can be indexed, such as a first element and a second element. In this case, unless stated otherwise, this indexation is only meant to differentiate and name elements which are similar but not identical. No idea of priority should be inferred from such indexation, as these terms can be switched without betraying the invention. Additionally, this indexation does not imply any order in mounting or use of the elements of the invention.

A heat exchanger for exchanging heat between a first fluid and a second fluid is disclosed in accordance with an embodiment of the present invention. The heat exchanger includes a first manifold, a second manifold, a bundle of heat exchange elements and a housing. The bundle of heat exchange elements for the first fluid axially extend and provide a fluidal communication between the manifolds. The housing for the second fluid encapsulates at least part of the heat exchange elements to form a fluid tight channel for the second fluid. The housing further includes at least one sacrificial component being of material having lower galvanic potential than the remaining components.

Generally, the sacrificial component is part of the housing.

Particularly, the sacrificial component is attached to the housing.

More specifically, the sacrificial component is attached directly to at least one heat exchange element.

Particularly, the heat exchange elements are flat tubes and the sacrificial component is parallel to and in contact with the flat surface of at least one terminal heat exchange element of the bundle.

Further, at least one of the manifolds includes a collar at least partially overlapping the bundle of heat exchange elements in assembled configuration of the heat exchanger.

In accordance with an embodiment of the present invention, the sacrificial component is fixed between the bundle of heat exchange elements and the collar.

Particularly, the sacrificial component includes at least one recessed section extending from a median section of the shorter side thereof.

Further, the sacrificial component includes at least a pair of projections located on opposite ends of the shorter side thereof.

Specifically, at least one of the projections includes a sloping portion configured to facilitate fixing the sacrificial component between the bundle of heat exchange elements and the collar.

Preferably, the sacrificial component is an auxiliary plate that includes at least one opening, so that opening partially uncovers the surface of at least one heat exchange element.

Particularly, the auxiliary plate includes four openings, wherein the openings are located symmetrically with respect to axis of symmetry of the auxiliary plate, so that a first median bar and a second median bar are created, wherein the median bars intersect each other perpendicularly in the middle of the auxiliary plate.

Generally, the at least one plate defining the housing is of Al—Zn alloy.

Particularly, the plate is of Al—Zn alloy and the proportion of zinc in the Al—Zn alloy is in the range of 1 to 2 percent.

More particularly, the plate is of Al—Zn alloy and the proportion of zinc in the Al—Zn alloy is 1.5 percent.

### BRIEF DESCRIPTION OF THE DRAWINGS

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

FIG. 1 illustrates an isometric view of a heat exchanger in accordance with an embodiment of the present invention, in the FIG. 1 the heat exchanger is depicted with one manifold of the pair of manifolds;

FIG. 2 illustrates a sectional view of the heat exchanger depicting internal details thereof;

FIG. 3 illustrates another isometric view of the heat exchanger of FIG. 1;

FIG. 4 illustrated an isometric view of the heat exchanger depicting both the manifolds;

FIG. 5 illustrates an isometric view of a sacrificial component of the heat exchanger of FIG. 1, wherein the sacrificial component is an auxiliary plate; and

FIG. 6 illustrates an isometric view of the manifolds of the heat exchanger of FIG. 4.

### DETAILED DESCRIPTION OF THE INVENTION

It must be noted that the figures disclose the invention in a detailed enough way to be implemented, said figures helping to better define the invention if needs be. The invention should however not be limited to the embodiment disclosed in the description.

Although the present invention is described with example of heat exchanger used in vehicular environment, wherein the heat exchanger is formed with a sacrificial component that undergoes corrosion to prevent corrosion of the other critical components of the heat exchanger. The heat exchanger of such configuration, particularly, the heat exchanger with sacrificial components is capable of preventing problems arising due to corrosion of the critical components of the heat exchanger and the heat exchanger exhibits improved service life and involves reduced maintenance compared to the conventional heat exchangers. However, the present invention is also applicable for heat exchangers that are used in non-vehicular environments. Further, the present invention is also applicable to other critical equipment that are subjected to corrosive environments and are prone to damage, frequent maintenance and replacement due to exposure to such corrosive environments.

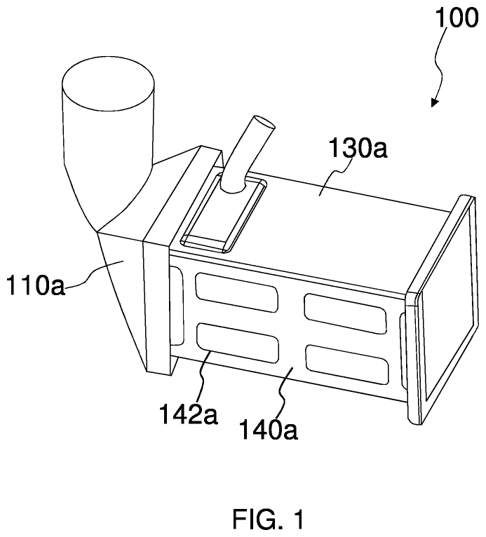

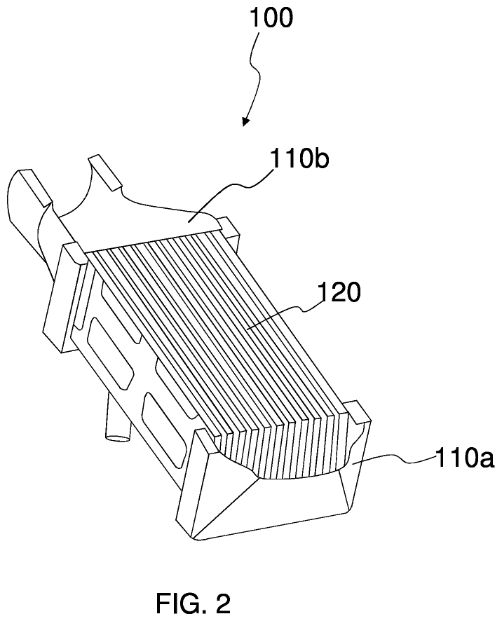

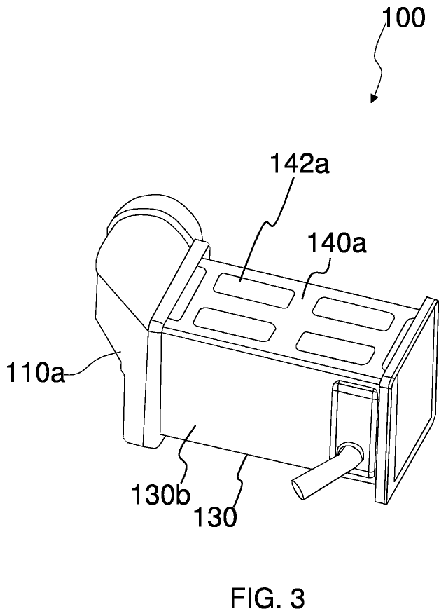

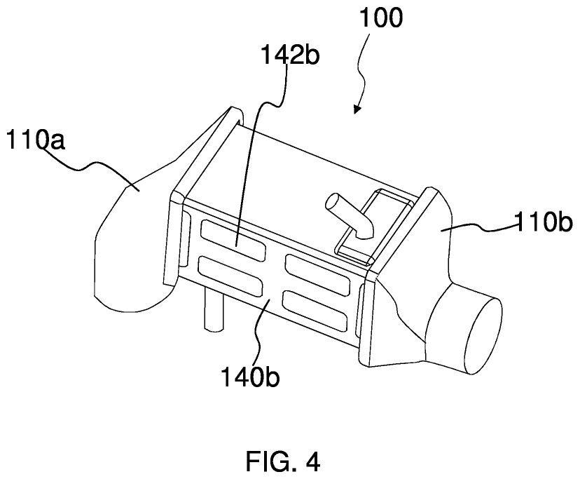

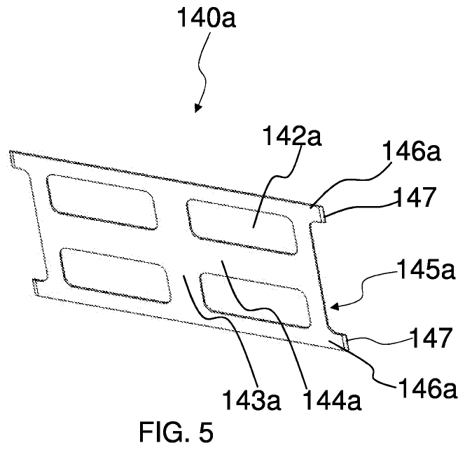

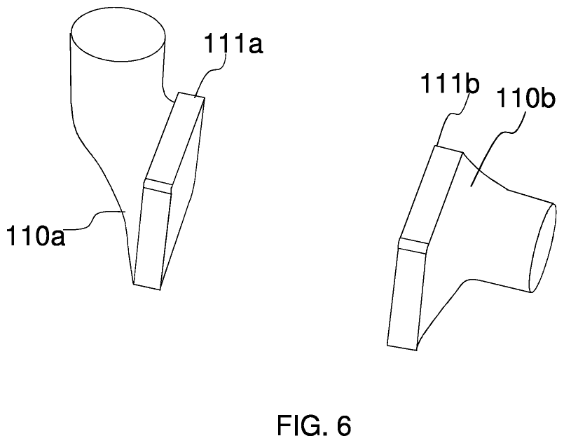

FIG. 1 illustrates an isometric view of a heat exchanger 100 in accordance with an embodiment of the present invention. The heat exchanger 100 includes a first manifold 110a, a second manifold 110b, a bundle of heat exchange elements 120 and a housing 130. The heat exchanger 100 further includes at least one sacrificial component. In the FIG. 1, the heat exchanger 100 is depicted with one manifold of the pair of manifolds 110a and 110b. FIG. 2 illustrates a sectional view of the heat exchanger 100 depicting internal details thereof. FIG. 3 illustrates another isometric view of the heat exchanger 100. FIG. 4 illustrated an isometric view of the heat exchanger 100 depicting both the manifolds 110a and 110b. FIG. 5 illustrates an isometric view of the sacrificial component of the heat exchanger, wherein the sacrificial component is an auxiliary plate. FIG. 6 illustrates an isometric view of the manifolds of the heat exchanger 100.

Referring to the FIG. 2 of the accompanying drawing, the bundle of heat exchange elements 120 for the first fluid axially extend and provide a fluidal communication between the manifolds 110a and 110b. In accordance with one embodiment, the heat exchange elements 120 are tubes connecting the first manifold 110a and the second manifold 110b and are in fluid communication with the first manifold 110a and the second manifold 110b. Specifically, the heat exchange tubes 120 configure fluidal communication between the first manifold 110a and the second manifold 110b. The first heat exchange fluid flows from the first manifold 110a to the second manifold 110b through the heat exchange tubes, in the process exchanging heat with a second heat exchange fluid flowing around the heat exchange tubes and across the heat exchange tubes. In accordance with another embodiment of the present invention, the heat exchange elements 120 are plates that configure fluid flow passages between a first set of adjacent plates to configure fluidal communication between the first manifold 110a and the second manifold 110b. The first heat exchange fluid flows from the first manifold 110a to the second manifold 110b through the flow passages defined between the first set of adjacent plates, in the process exchanging heat with a second heat exchange fluid flowing across a second set of adjacent plates.

Referring to the FIGS. 1, 2, 3 and 4 of the accompanying drawings, the housing 130 for receiving the second fluid encapsulating at least part of the heat exchange elements 120 to form a fluid tight channel for the second fluid is illustrated. The housing 130 includes an inlet and an outlet. The inlet is in fluid communication with the fluid tight channel for ingress of the second fluid in the fluid tight channel. The outlet is in fluid communication with the fluid tight channel for egress of the second fluid from the fluid tight channel. In one embodiment of the present invention, the housing 130 includes a top plate 130a, a bottom plate 130b and a pair of side plates interconnecting the top plate 130a and the bottom plate 130b, which can be referenced to as housing plates. The open ends of the housing 130 are closed by the first and the second manifolds 110a and 110b respectively to define the enclosure. In accordance with another embodiment of the present invention, the housing 130 includes the top plate 130a, the bottom plate 130b and the terminal heat exchange elements act as the side plates. The terminal heat exchange elements are the heat exchange elements disposed at the terminal sides of the bundle of heat exchange elements that are either one of flat heat exchange tube or heat exchange plates. In case, the terminal heat exchange elements act as the side plates, the first and the second manifolds 110a and 110b close the ends of the housing 130.

The sacrificial component of the heat exchanger 100 undergoes corrosion to reduce the effect of corrosive environments on the critical components of the heat exchanger 100. More specifically, the sacrificial component is of material having lower galvanic potential than the remaining critical components of the heat exchanger 100 that causes the sacrificial component to corrode earlier and thus prevent corrosion of other critical components of the heat exchanger 100. With such configuration of the heat exchanger 100, particularly, the heat exchanger 100 with sacrificial component, the corrosion and damage to the critical heat exchange components such as the heat exchange tubes is prevented, thereby preventing leakage and problems caused by the leakage of the heat exchange fluid. The sacrificial component also covers the critical elements of the heat exchanger 100 to protect the same from corrosion and other harsh environment conditions.

The sacrificial component is either part of the housing 130 or attached to the housing 130. In case the housing 130 of the heat exchanger 100 includes side plates, the sacrificial components are attached to the side plates. In case the housing 130 does not include the side plates and the terminal heat exchanger elements 120 act as the side plates, the sacrificial components are directly attached to at least one of the terminal heat exchange elements 120. In one embodiment of the present invention, the heat exchange elements 120 are flat tubes and at least one sacrificial component 140a, 140b is disposed parallel to and in contact with the flat surface of at least one terminal heat exchange element 120 of the bundle.

The heat exchanger 100 further includes arrangement for securely attaching the sacrificial component to the housing 130 of the heat exchanger 100. Referring to FIG. 6 of the accompanying drawings, the at least one of the first and the second manifolds 110a and 110b includes a collar 111a, 111b at least partially overlapping the bundle of heat exchange elements 120 in assembled configuration of the heat exchanger 100. The sacrificial component 140a, 140b is fixed between the bundle of heat exchange elements 120 and the collar 111a, 111b. Preferably the sacrificial component 140a, 140b is in the form of the plate of rectangular configuration as illustrated in FIG. 5.

In accordance with one embodiment, the heat exchanger 100 includes two sacrificial components, particularly two plates, a first plate 140a also referred to as first auxiliary plate and a second plate 140b also referred to as the second auxiliary plate disposed at opposite sides of the heat exchanger 100. More specifically, the first plate 140a and the second plate 140b cover the respective terminal flat tubes of the bundle of heat exchange tubes 120 or the first plate 140a and the second plate 140b cover the side plates, if the housing 130 includes the side plates. In the forthcoming description, configuration of one of the two plates, particularly, the first plate 140a is described in details. As the second plate 140b acting as the sacrificial component is structurally and functionally similar to the first plate 140a, for the sake of brevity of the present document, the second plate 140b is not described in details. In accordance with another embodiment of the present invention, at least one of the top plate 130a and the bottom plate 130b is the sacrificial component. In accordance with still another embodiment of the present invention, at least one of the side plates of the housing 130 is the sacrificial component.

Referring to FIG. 5 of the accompanying drawings, the sacrificial component in the form of the plate includes at least one recessed section 145a extending from a median section of the shorter side thereof. The first plate 140a includes at least a pair of projections 146a located on opposite ends of the shorter side thereof, wherein at least one of the projections 146a includes a sloping portion 147a configured to facilitate fixing the first plate 140a between the bundle of heat exchange elements 120 and the collar 111a, 111b. In one embodiment, each of the projections 146a include the sloping portion 147a at extreme end thereof. However, the present invention is not limited to any particular configuration, any particular shape of the first plate 140a, the projections 146a formed on the plate 140a and the sloping portions 147a formed on the projections 146a, as far as the sacrificial component is capable of being attached to either to the side plates or the terminal flat tubes in case housing 130 does not include the side plates. Further, the present invention is not limited to any particular method of attaching the first plate 140a to either the side plate or terminal flat tube in case the terminal flat tube acts as the side plate. The first plate 140a can be brazed either to the side plates incase the heat exchanger includes the side plates or to the terminal flat tubes in case the heat exchanger does not include the side plates and the terminal flat tubes acts as the side plates.

The first plate 140a includes at least one opening 142a. In case the housing 130 does not include side plates and the terminal heat exchange element 120 acts as the side plates, the openings 142a on the first plate 140a, partially uncovers the surface of the at least one terminal heat exchange elements 120. In case the heat exchanger 100 includes at least one side plate, the sacrificial component is attached to and disposed overlapping the side plate to partially uncovers the surface of the side plate.

In accordance with an embodiment of the present invention, the first plate 140a acting as the sacrificial component includes four openings 142a. With such configuration of the plate with openings, the weight reduction is achieved. The openings 142a are located symmetrically with respect to axis of symmetry of the first plate 140a. More specifically, the openings 142a are disposed on opposite sides of a first bar 143a and a second bar 144a, wherein the first and the second bars are median bars 143a, 144a that intersect each other perpendicularly in the middle of the first plate 140a as illustrated in FIG. 5. In accordance with yet another embodiment of the present invention, the first and second bars 143a and 144a are at an angle with respect to each other. In accordance with an embodiment of the present invention, the total area of the openings 142a is greater than the surface area of the remaining surface of the first plate 140a. In accordance with another embodiment, the total area of the openings 142a is less than the surface area of the remaining surface of the first plate 140a. In accordance with yet another embodiment, the total area of the openings 142a is equal to the surface area of the remaining surface of the first plate 140a. More specifically, the present invention is not limited to any particular configuration of the bars 143a and 144a, orientation of the bars 143a and 144a with respect to each other and number, placement and pattern of the openings 142a formed on the first plate 140a, as far as the openings 142a partially uncovers the surface of the terminal heat exchange element 120 or the side plate based on whether the first plate 140a is attached to the terminal heat exchange element 120 or the side plate.

Generally, the sacrificial component, at least one plate 130a, 130b, 140a, 140b is of Al—Zn alloy. Specifically, the proportion of zinc in the Al—Zn alloy is in the range of 1 to 2 percent. More specifically, the proportion of zinc in the Al—Zn alloy is 1.5 percent.

What is claimed is:

1. A heat exchanger for exchanging heat between a first fluid and a second fluid, the heat exchanger comprising:
a first manifold and a second manifold,
a bundle of heat exchange elements for the first fluid axially extending and providing a fluidal communication between the first and second manifolds,
a housing for the second fluid encapsulating at least part of the heat exchange elements to form a fluid tight channel for the second fluid,
wherein
the housing includes at least one sacrificial component being of material having lower galvanic potential than the remaining components.

2. The heat exchanger according to claim 1, wherein the at least one sacrificial component is part of the housing.

3. The heat exchanger according to claim 1, wherein the at least one sacrificial component is attached to the housing.

4. The heat exchanger according to claim 1, wherein the at least one sacrificial component is attached directly to at least one heat exchange element of the bundle of heat exchange elements.

5. The heat exchanger according to claim 4, wherein the heat exchange elements are flat tubes and the at least one sacrificial component is parallel to and in contact with the flat surface of at least one terminal heat exchange element of the bundle of heat exchange elements.

6. The heat exchanger according to claim 1, wherein at least one of the manifolds includes a collar at least partially overlapping the bundle of heat exchange elements in assembled configuration of the heat exchanger.

7. The heat exchanger according to claim 6, wherein the at least one sacrificial component is fixed between the bundle of heat exchange elements and the collar.

8. The heat exchanger according to claim 1 wherein the at least one sacrificial component includes at least one recessed section extending from a median section of the shorter side thereof.

9. The heat exchanger according to claim 1, wherein the sacrificial component includes at least a pair of projections located on opposite ends of the shorter side thereof.

10. The heat exchanger according to claim 9, wherein at least one of the projections includes a sloping portion configured to facilitate fixing the at least one sacrificial component between the bundle of heat exchange elements and the collar.

11. The heat exchanger according to claim 4, wherein the at least one sacrificial component is an auxiliary plate that includes at least one opening, so that it partially uncovers the surface of at least one heat exchange elements.

12. The heat exchanger according to claim 4, wherein the at least one sacrificial component is an auxiliary plate that includes four openings, so that it partially uncovers the surface of at least one heat exchange elements, wherein the four openings are located symmetrically with respect to axis of symmetry of the auxiliary plate, so that a first median bar and a second median bar are created, wherein the median bars intersect each other perpendicularly in the middle of the auxiliary plate.

13. The heat exchanger according to claim 1, wherein the housing is at least partially formed by housing plates, wherein at least one of the housing plates is of Al—Zn alloy.

14. The heat exchanger as claimed in claim 13, wherein the proportion of zinc in the Al—Zn alloy is in the range of 1 to 2 percent.

15. The heat exchanger as claimed in claim 14, wherein the proportion of zinc in the Al—Zn alloy is 1.5 percent.
